(19) United States
(12) Patent Application Publication
(10) Pub. No.: US 2016/0132472 A1
(43) Pub. Date: May 12, 2016

(54) PROCESS INTELLIGENCE SYSTEM

(71) Applicant: Tulkita Technologies Inc., Toronto (CA)

(72) Inventors: James Campbell, Toronto (CA); Heather Gardiner, Toronto (CA); Robert Schenkel, Toronto (CA); Matthew Hum, Toronto (CA)

(73) Assignee: Tulkita Technologies Inc., Toronto (CA)

(21) Appl. No.: 14/535,297

(22) Filed: Nov. 6, 2014

(51) Int. Cl. G06F 17/24; G06F 17/22; G06F 17/30; G06F 3/0484

(52) U.S. Cl. CPC G06F 17/24; G06F 17/248; G06F 3/04847; G06F 17/2288; G06F 17/30572

(57) ABSTRACT

A system and a method for constantly improving process efficiency and consistency are disclosed herein. A preferred embodiment of the system comprises a database, a user interface, a change tracking module, and a feedback module. The database stores one or more electronic assets. The user interface allows a user to select an electronic asset as a template and automatically create a work product based on the template. The change tracking module monitors the use of the selected electronic asset with one or more describing properties such as the changes made to the working product and time used for finalizing the work product. Then, the feedback module may analyze the one or more describing properties and provide a feedback as to how to improve the selected electronic asset.

### FIELD OF THE INVENTION

The present invention relates to a process intelligence method and system and more specifically to an interactive computer method and system for monitoring, tracking and providing feedback on changes made to electronic assets.

### BACKGROUND OF THE INVENTION

Improving process efficiencies is desirable among those individuals and businesses that perform repetitive tasks. Business process intelligence, also referred to as operational intelligence and semantic business process management, is an emerging area of technology with the goal of improving efficiencies associated with the performance of repetitive tasks.

Currently, users performing repeatable tasks in known applications such as Microsoft Word™, Project™ and Excel™ are not able to capture changes made to documents in the respective applications.

Different solutions have been devised to solve improving process efficiencies. For example, Microsoft SharePoint™ provides a platform for collaboration, document and file management, and business intelligence, among other things.

Other business intelligence software currently available includes SAP Operational Process Intelligence software by SAP AG, which provides a data platform that correlates and contextualizes structured operational data from end-to-end processes in real time, and Software AG's ARIS™ Business Process Analysis Platform, which is designed for organizations that want to document, analyze, standardize and improve their processes.

The systems currently available do not harvest information from electronic assets and it is lost when changes are made to the assets and the assets are then saved, for example, in applications such as Microsoft Word™, Project™, and Excel™. These assets also often serve as “templates” as the assets are copied and cleaned so that they can be used again. However, little or no link is created between the original static asset and the derived asset.

There is a need for a system that uses real-time data from electronic assets that can be managed, manipulated and used as required for analytics, reporting and continuous improvement of the electronic assets allowing for business process efficiency and delivery consistency.

### SUMMARY OF THE INVENTION

The structure, overall operation and technical characteristics of the present invention will become apparent with the detailed description of preferred embodiments and the illustration of the related drawing as follows.

The invention is incorporated in a system and a method for constantly improving process efficiency and consistency. A preferred embodiment of the system comprises a database, a user interface, a change tracking module, and a feedback module. The database stores one or more electronic assets (i.e. templates, such as a contract, a work proposal, an estimator of timelines, and so forth) and preferably their corresponding properties. The properties of an electronic asset may include a unique ID, a name, a type, a description of the asset, and so forth. The electronic assets and if any, their properties may be created, edited, duplicated, and managed by an administrator of the embodiment, or by any user authorized to do so, preferably via a user interface, depending on the implementation of the system. An embodiment may also allow the system administrator to control permissions of users or groups of users to access the electronic assets in the database.

The user interface in the preferred embodiment allows a user to choose from the one or more electronic assets. After an electronic asset is selected, the embodiment automatically creates an editable work product. Immediately after the work product is created, the change tracking module in the embodiment adds a link between the selected electronic asset and the work product to the database. The link in this embodiment preferably has one or more various describing properties for the change tracking module to collect information concerning how the selected electronic asset is used in this instance. Examples of a describing property include whether and how the work product is changed or different from the selected electronic asset, how long it takes the user to finish editing the work product, and so forth. The change to the work product may include a status such as “modified” or “no-change.”

The change tracking module in the preferred embodiment includes the necessary hardware and software configured to monitor how the user is using the electronic asset, through the user's use of work product. For instance, if a describing property in an embodiment corresponds to the time used for editing the work product, the change tracking module of this embodiment may include a timer. If a describing property in another embodiment corresponds to the change to the work product, the change tracking module may include a computer with a software program executed to compare the differences between the final work product and the selected electronic asset. This way, the change tracking module knows not only whether there is a change but also where the change is located. Alternatively, when an electronic asset in the embodiment is a Microsoft Word™ document, the change tracking module may simply determine that the work product has changed because the “date created” property of the work product is different from its “date modified” property.

For an embodiment that the locations of changes in the selected electronic asset may be determined, some differences may be ignored from the change tracking module's analysis of changes. For example, when an electronic asset is a company's template non-disclosure agreement, changes made to a work product such as the other party's name, address, and signer's title do not affect the usefulness of the template. Therefore, these changes may be ignored and not saved to any describing properties.

Additionally, an electronic asset in the preferred embodiment may be divided and thus further include one or more asset items. As such, a work product of the selected electronic asset may comprise at least one work product item corresponding to the at least one asset item. The link between the work product and the selected electronic asset may further comprise at least one item link between an asset item and a work product item, and each item link may include at least one item describing property for storing information such as how the work product item is changed from the asset item. But if a work product item is created by the user, then the at least one item link may correspond to the work product item but no matching asset item. When an item describing property in an embodiment stores a status or a change to the work product item, the status or change may include “added,” “deleted,” “modified,” and “no-change.”

After information is collected by the change tracking module, the feedback module of the preferred embodiment may analyze, either periodically or real-time, a use of the selected electronic asset based on the one or more describing properties and if any asset items exist, the one or more item describing properties. One or more algorithms may be adopted for analyzing the use of the selected electronic asset. Examples of the algorithms may include: count, longest common sequence, min, max, mean, standard deviation, and so forth.

Based on its analysis, the feedback module of the preferred embodiment may generate a feedback such as an average time for editing work products of an electronic asset, and recommendations regarding how to improve an electronic asset or its asset items. For example, if an embodiment where an item describing property shows that in many work products of an electronic asset, the work product item is often deleted (such as 80% of the work products in a year), then the feedback module may suggest hiding or even removing the asset item from the electronic asset.

Finally, in a preferred embodiment with at least one asset item for an electronic asset, the user interface may further include a wizard for customizing a work product. After an electronic asset is selected, the wizard may prompt the user to answer at least one pre-existing question by provide a list of possible answers to choose from. Based on the selected answer(s), the embodiment may then determine whether to include a specific work product item in the work product. The feedback module of this embodiment may also evaluate the efficacy of the wizard based on the use of the selected electronic asset and then include the efficacy of the wizard in the feedback. For example, if users generally spend more time on the work products of an electronic asset customized by the wizard than on those without using the wizard, the feedback module may report the results and recommend that the wizard be improved.

As to the method of this invention, a preferred embodiment comprises the steps of using a system or systems that incorporate any implementations or their alterations in part or wholly as described above.

An object of this invention is to constantly improve the efficiency of performing repetitive processes.

Another object of this invention is to continually improve the quality of the electronic assets.

Yet another object of this invention is to provide an objective standard for evaluating how efficiently and effectively a user uses the electronic assets.

### BRIEF DESCRIPTION OF THE FIGURES

These and other aspects of the present invention will be apparent from the brief description of the drawings and the following detailed description in which:

FIG. 1 is a simplified schematic of a computer system supporting various embodiments of the present invention;

FIG. 2 is an illustration of linked electronic assets in a methodology according to an embodiment of the present invention;

FIG. 3 is an example of an electronic asset with embedded items according to an embodiment of the present invention;

FIG. 4 is a flow diagram of an embodiment of the system of the present invention;

FIG. 5 is a flow diagram of an embodiment of the system of the present invention;

FIG. 6 is a flow diagram of an embodiment of the system of the present invention having a wizard.

### DETAILED DESCRIPTION OF THE FIGURES

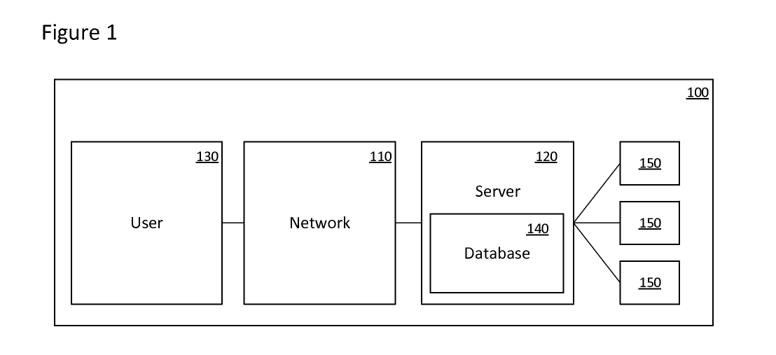

As shown in FIG. 1, in an embodiment of the present invention, there is provided a system 100 for carrying out process intelligence over a network 110. The system operates by way of a server 120, which may be provided by real server hardware or by virtual hardware simulated by software running on one or more real machines, often referred to as cloud computing. The system 100 includes one or more electronic devices (not shown) that communicate with the server 120 over a network 110. The system 100 operates over the network 110 by one or more users 130, where content is distributed through the network on the server, and process intelligence functionality is provided by the server having a database 140.

The electronic devices include personal computers, lap top computers, tablets, smart phones, mobile telephones, personal digital assistants or any other electronic device having: a user interface for receiving commands and data from a user; a communications interface for exchanging data with the server 120 over the network 110; and a display for providing information to the user. The electronic devices may be configured to support the system 100.

The network 110 comprises a wired or wireless communications network or a combination of wired and wireless communications networks. The network 110 may be public or private, or any combination thereof and may provide secure communications using encryption techniques. The network 110 supports communications between the electronic devices and the server.

The database 140 contains electronic assets 150. The electronic assets are templates which are created for general use or for a specific user of the system. A template may stand on its own as a standalone template or may be linked in a series of templates that reflect processes or methodologies. Examples of standalone templates may include any form of a document, for example legal agreements, customer service forms, or any standard form agreement or document that utilizes a standard structure or general content. Although the term document is used throughout this description, it is understood that a document may include documents, spreadsheets, presentations, surveys, plans, estimators, assessments, or any other record that may be stored in a database.

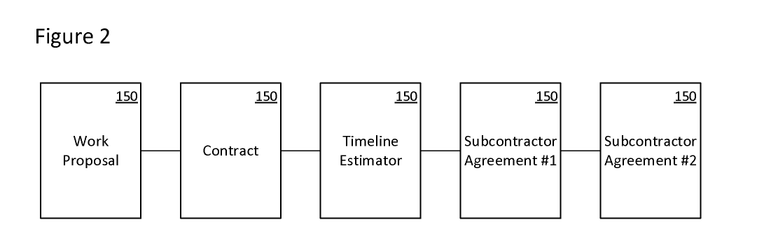

Templates may be associated or linked with one another in the instance of processes or methodologies. For example, as shown in FIG. 2, a construction project may be a methodology that includes multiple associated or linked standalone templates that may comprise a work proposal, a contract, an estimator of timelines, and agreements with sub-contractors. Processes can also be linked or associated with other processes in which instance the two or more linked processes are now sub-processes in an overarching process. By associating templates together, consistency of use and analytics to be performed across the group may be achieved.

There is no difference at the template level as there is no difference between a standalone template, one that is associated to a process or one that is associated to multiple processes. The structure of how it is saved is identical.

In an embodiment of the present invention there is provided change tracking module configured to automatically create and store to the database a link between the selected electronic asset and the work product, the link comprising at least one describing property, and automatically store, to the at least one describing property, at least a change to the work product.

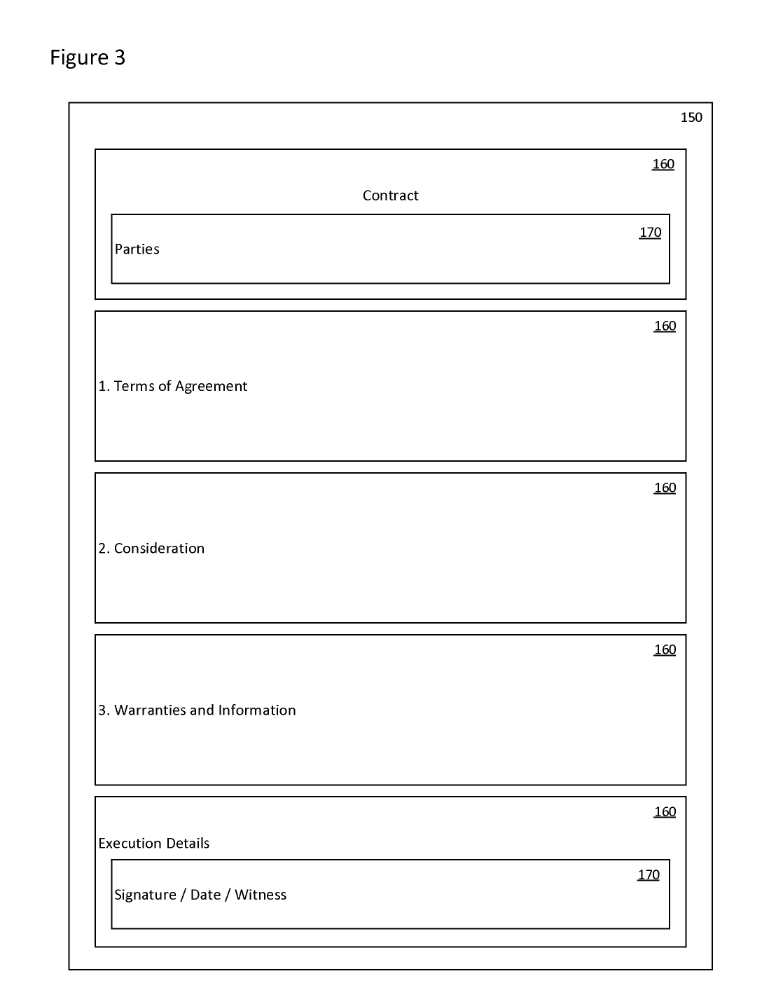

As shown in FIG. 3, the content of a template 150 is divided into individual items 160. In an embodiment of the invention, an item may have two parts, the structure and the content. The structure is what is to be populated in the template and the content is provided by the user filling out the document. The structure of a work product is set up from the template. For example, the paragraphs of a document, or the steps of a plan. However the details, or content, are then filled out like an online form.

For documents, items may include paragraphs, and for plans and task lists, items may include individual tasks. Every item has a describing property which stores its current state. Each process or template and item contains describing properties which may be in the form of metadata that is associated and stored in the database for the process or template. The describing property may relate to the structure and/or organization of the template, or the describing property may relate to the content of the template. The type of metadata for describing properties stored are dependent on the type of template that is being created.

In an embodiment, the structure and the content of the template 150 is provided with an item 160 that may be tracked, monitored and analyzed. For example, as shown in FIG. 3, the name of the contract, information relating to the parties of the contract, the terms of the agreement, consideration, warranties and indemnities, and execution details are items that are tracked, monitored and may be analyzed by the system. Within each item there may be additionally provided embedded items 170. For example, as shown in FIG. 3, the execution details item 160 has embedded items relating to the signature, date and witness of the contract template 150. The embedded items are also provided with a describing property which stores its current state.

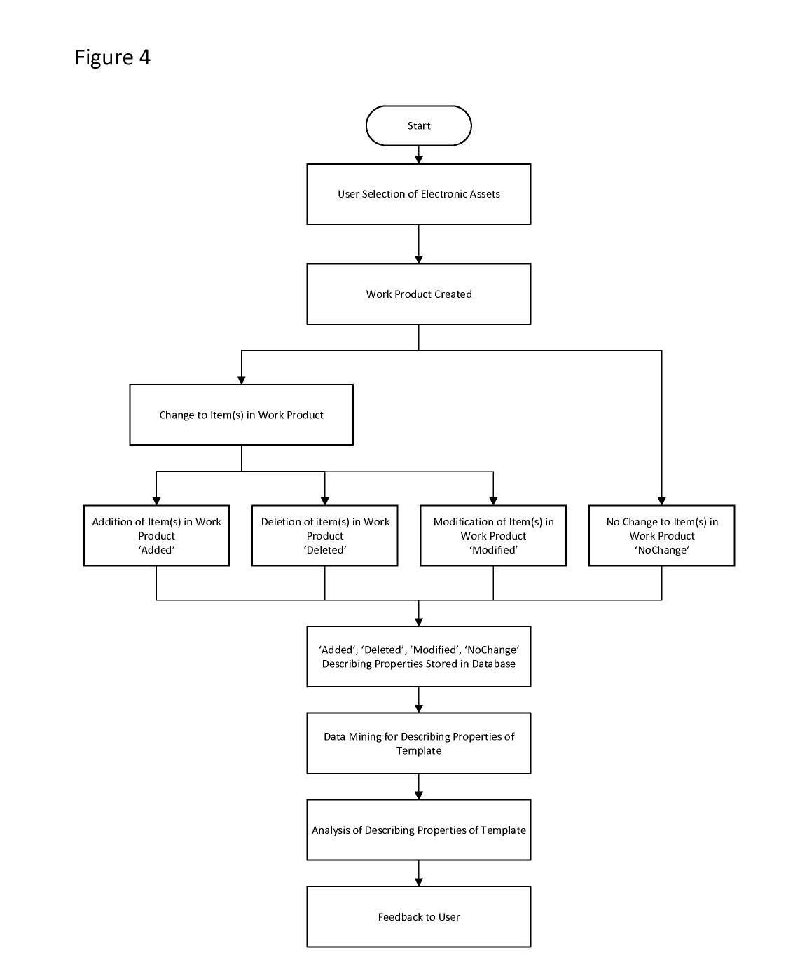

As shown in FIG. 4, in an embodiment of a method of use of the present invention, a user selects an electronic asset from the database, which becomes the user's work product. A link between the work product and the template that the work product was derived from is preserved in the database. The link acts as a pointer from the work product to the template it was derived from.

All templates in the database may be standardized. Standardization of the templates allows the user of the system to assume that the same documents are being used for like projects. This increases knowledge transfer and decreases time needed to develop the template. Also, as the templates used each start out as being standardized, changes can be tracked and added to a feedback loop (described below). If a template was always customized it would be difficult to find, monitor and analyse differences between the template and the work product and recommend changes to a template.

In an embodiment of the present invention, when a user is looking for a template in the database, they can preview the template before creating a work product. The preview builds out a sample work product without the interaction from the user. This allows the user to see what the template would look like before they choose to use it, thereby creating a work product.

Each template of this embodiment is stored in the database with a unique identifier and each work product is stored in the database with a unique identifier. When a work product is created the unique identifier from the template and version of the template it was derived from is stored in a describing property of the work product in the database. This allows every work product to be tied back to the template from which it was derived. The database also organizes the electronic assets in a table listing work products created when the templates are in use.

In this embodiment, every time a work product is created a row is inserted in a table in the database. Each row has a unique identifier. In an embodiment of the present invention, the unique identifier is an incremental ID such as an integer, but it is understood by a person skilled in the art that any unique identifier could be used. In an embodiment of the present invention, the unique identifier is an auto-incrementing ID. In one of the columns of the row the unique identifier of the template it was derived from is stored. This allows for a simple count of the work products to be performed. The process is similar for the items of the work product.

As shown in FIG. 4, a user may insert, delete or otherwise modify a work product. The user may also use the template as is and make no changes to the describing properties of the work product. A describing property is set and stored through the link or links between the template and the work product in the database indicating that the item either exists or does not exist in the template that the work product was derived from and noting the differences that exist between the template and work product.

Further links exist between each item of a work product and the same items from the template that the work product item was derived from; these links are preserved in the database from which the templates originate, with the describing properties segmented in different database tables within the database. It would be understood to one skilled in the art that a separate database could also be utilized. The template may be predetermined or customized to determine which of the elements of the template are linked to the work product. For example, in a template the date or name of a party may not be linked between the work product and the template. If an item is derived from a template then the link is always present. The only time a work product item would not be tied to a template item is if it was a new item that the user has added to the work product. Analytics from the template can be run on items that were added to work products which items do not exist in the template.

When a work product is first created from a template the state of each of the items is set to “NoChange”. If the user modifies the item (i.e. changes it from that which was in the template) the state is changed to “Modified”. If the user deletes (or hides) an item the state is changed to “Deleted”. If a user adds a new item its state is set to “Added”.

As herein described, the states of each item are as follows:
NoChange—The default state. When a work product is created from a template all the corresponding template items are created within the work product with a status of NoChange. This indicates to the system that the item is identical to the corresponding template item.
Modified—This state occurs when a modification is performed on the work product item. The work product item is no longer identical to the corresponding template item.
Deleted—This state occurs when an item that was present in the template is removed from the work product. The actual item is not removed from the work product, instead the state is changed to “deleted”.
Added—This state represents that an item has been added to the work product that does not exist in the template. Added items will always stay in a state of added. Modifying it after it has been added has no effect as the item is still new.

The describing property of the change (Modified, Deleted, or Added) or NoChange is stored in an audit log within the database. Accordingly, a complete history of what changed and how it was changed is created.

In an embodiment of the invention, analytics of the changes and no changes are done at the template level. As each work product has a pointer to the template it was derived from and each item has a pointer to the item in the template it was derived from, at a template level, it is possible to determine how many times the template or its items were changed and what the changes were. In a further embodiment of the invention, analytics of the changes and no changes are done at the system or methodology level, the process level, and the template level.

In an embodiment of the system, there is a method for providing feedback on the use of the templates, either standalone or linked to other templates. In an embodiment, there is provided a feedback module configured to automatically analyze a use of the selected electronic asset based on the at least one describing property, and automatically generate a feedback based on the use of the selected electronic asset.

The feedback is provided by way of a feedback loop based on the analytics conducted on the changes or no changes of the template(s).

In order for the feedback loop to take place, the data stored in the database is mined to locate all describing properties for all work products derived from a template, or templates associated with a plan or process. The describing properties that are mined may relate to structural changes, content changes, or both. The resulting data is then run through a series of algorithms. Examples of algorithms may include longest common sequence, min, max, mean, and standard deviation and are used to identify trends, additions, omissions, and exceptions within the describing properties. The algorithms used may be known, or may be customized to a specific template or series of linked templates.

A report may be generated setting out the results of the data that have been run through the algorithms and to recommend changes to templates based on usage analytics produced through the data mining.

For example, template ABC for a plan indicates that a task should take 10 hours over 3 days. The template has been turned into a work product 25 times and the mean time for the task is 15 hours with a standard deviation of 2 hours. The embodiment of the system of the present invention makes recommendations to update the estimated hours in a template to reflect the amount of time it has taken in practice.

When a template is used as part of a process or a methodology then analytics are produced at those levels. In an embodiment of the present invention, the percentage of time a work product is produced from a template that is part of the process is measured. This information is used to make sure a process is being used correctly and also for updating the process. If a template from the process is never used then what the users are using instead is determined and can then be added to the process and the previous unused template removed.

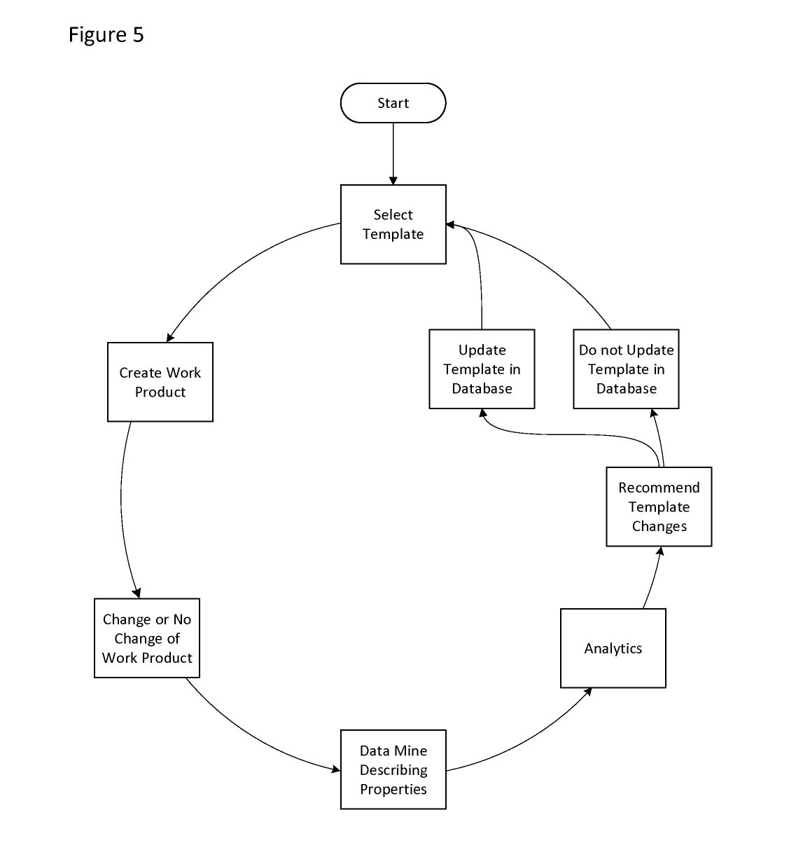

An example of the system of the present invention is shown in FIG. 5 in which a user selects a template from the database. A work product is created from the template which the user changes or does not change to suit the user's needs. The work product is saved by the user and the changes and no changes, which are describing properties, made to the items of the work product are sent to the database. The database is mined for describing properties associated with the template and analytics are performed on the describing properties. The system will recommend to the user changes that may be made to the template based on the results of the analytics. The user may then either make no changes to the template or may update the template in the database based on the recommendations, in which case the next time the template is selected from the database and a work product is created, the template and work product will be from the updated template that reflects the analytics conducted.

In a further embodiment of the present invention, templates and their resulting work products may be tagged for identification purposes. A template may be tagged before it is entered into the database, or a template may be tagged at a later date. An administrator of the system or an individual user may tag a template depending on how the system is set up. Tags may also be added to a work product or work products, either as a result of the template from which the work product is generated, or from the user tagging the work product. The tag added to the template and/or work products may be user defined values. For example, the tag may relate to the field in which the template/work product is used in, such as construction, legal, pharmaceutical, financial services, etc.

Tagging permits a user to search for templates and work products bearing the specific tag or tags. For example, if a user of the system is looking for a template for a plan, a list of plans may appear, and the tags may be used to narrow the applicable templates to those that have been tagged accordingly. This assists users in working from the most relevant template, and avoiding outliers.

The tags may also be used in the feedback loop so that the feedback loop is only performed on documents having a specific tag.

The following are two examples of methods of use of an embodiment of the system of the present invention. Example 1 is a method of use of the system for a standalone template. Example 2 is a method of use of the system for a process having more than one standalone templates that are associated with one another.

### EXAMPLE 1

### Standalone Template

Step 1: Create the Template

A template is created, which is provided with items; each item having describing properties.

Template

| Property | Value |
|---|---|
| Id | 1 |
| Name | Confidentiality Agreement |
| Version | 1.0 |
| Type | Document |
| Tags | Legal |

Template Item 1

| Property | Value |
|---|---|
| Id | 1 |
| TemplateId | 1 |
| Name | Introduction |
| Description | |
| Type | Paragraph |
| Text | CONFIDENTIALITY AGREEMENT |
| | Date: ##2## |
| | ABC INC. and ##3## (hereinafter |
| | individually referred as the “Party”, the |
| | “Owning Party”, the “Receiving Party”, as |
| | the case may be, and collectively referred |
| | to as the “Parties”) may exchange certain |
| | information that is non-public, confidential |
| | and/or proprietary in nature concerning their |
| | respective businesses, operations and products |
| | which each Party regards to be secret and |
| | desires to protect from unauthorized disclosure |
| | or use (hereinafter collectively, “Information”). |
| | The Parties are willing to disclose Information |
| | (as Owning Party) and receive Information (as |
| | Receiving Party) on the terms and conditions set |
| | forth herein. |
| | Intending to be legally bound, the |
| | Parties agree as follows: |
| Embedded | False |
| Required | True |

For Item 1, the properties are: Id, which is the items unique identifier; Templateld, which is a pointer which ties the item to its associated template; Name, which describes the Item 1's title; Description, which is not provided with a meaning in this case; Type, which describes that the Item 1 is a paragraph; Text, which sets out the text of the paragraph; Embedded, which in this case indicates that item 1 is not embedded within another item; and Required, which in this case is “true” and means that Item 1 is necessary to the template. Item 1 has a pointer to both item 2 (##2##) and item 3 (##3##), which will be filled in with content by the user in the work product. Item 2 and item 3 are separate “embedded” items. Item 2 and item 3 are saved in the database just as item 1 is. Like item 1, items 2 and 3 have structural and content components. In this example, structural changes are tracked and content changes are not tracked. Therefore if item 1 was changed so that it was no longer required, this deletion would be tracked. On the other hand populating the date and party would be filling in the content, i.e. content change, and therefore not tracked.

Template Item 2

| Property | Value |
|---|---|
| Id | 2 |
| TemplateId | 1 |
| Name | Effective Date |
| Description | The date upon which the agreement is |
| | considered to take effect. |
| Type | Text Input |
| Multiple Lines | False |
| Placeholder | Effective Date |
| Text | |
| Embedded | True |
| Required | True |

For Item 2, the properties are: Id, which is the items unique identifier; Templateld, which is a pointer which ties the item to its associated template; Name, which describes the Item 2's title; Description, which is provided with a meaning; Type, which describes that the Item 2 is text to be input by the user; Multiple Lines, which is false because the item is not over more than one line; Placeholder, indicates that the effective date is to be inserted by the user; Text, which has no value as it is to be completed by the user; Embedded, which indicates that item 2 is embedded within another item; and Required, which means that Item 2 is necessary to the template. Item 1 did not include “Multiple Lines” and “Placeholder”, but could have.

Template Item 3

| Property | Value |
|---|---|
| Id | 3 |
| TemplateId | 1 |
| Name | Party |
| Description | The person or group of persons that compose |
| | a single entity which are entering the |
| | agreement with Owning Party. |
| Type | Text Input |
| Multiple Lines | False |
| Placeholder | Party |
| Text | |
| Embedded | True |
| Required | True |

For Item 3, the properties are: Id, which is the items unique identifier; TemplateId, which is a pointer which ties the item to its associated template; Name, which describes the Item 3's title; Description, which is provided with a meaning; Type, which describes that the Item 3 is text to be input by the user; Multiple Lines, which is false because the item is not over more than one line; Placeholder, indicates that the party is to be inserted by the user; Text, which has no value as it is to be completed by the user; Embedded, which indicates that item 3 is embedded within another item; and Required, which means that Item 3 is necessary to the template.

Step 2: Select Template and Create Work Product

Work Product

| Property | Value |
|---|---|
| Id | 1 |
| ReferenceType | Template |
| ReferenceId | 1 |
| TemplateId | 1 |
| Name | Confidentiality Agreement |
| Type | Document |
| Tags | Legal |

The Id of the work product relates back to the unique identifier. The reference type tells one if the user selected the template from a methodology, process, or template. The reference id is a pointer to the unique identifier of the referenced methodology, process, or template, allowing a work product to be tied back to a specific methodology or process.

Work Product Item 1

| Property | Value |
|---|---|
| Id | 1 |
| WorkProductId | 1 |
| TemplateItemId | 1 |
| Name | Introduction |
| Description | |
| Type | Paragraph |
| Text | CONFIDENTIALITY AGREEMENT |
| | Date: ##2## |
| | ABC INC. and ##3## (hereinafter |
| | individually referred as the “Party”, the |
| | “Owning Party”, the “Receiving Party”, as |
| | the case may be, and collectively referred |
| | to as the “Parties”) may exchange certain |
| | information that is non-public, confidential |
| | and/or proprietary in nature concerning their |
| | respective businesses, operations and products |
| | which each Party regards to be secret and |
| | desires to protect from unauthorized disclosure |
| | or use (hereinafter collectively, “Information”). |
| | The Parties are willing to disclose Information |
| | (as Owning Party) and receive Information (as |
| | Receiving Party) on the terms and conditions set |
| | forth herein. |
| Embedded | False |
| Required | True |
| State | NoChange |

All properties are considered structural. The State is an additional Property in Work Products. In this example, the property of State is given the value of “NoChange” since no change has been made between the template and the Work Product.

Work Product Item 2

| Property | Value |
|---|---|
| Id | 2 |
| WorkProductId | 1 |
| TemplateItemId | 2 |
| Name | Effective Date |
| Description | The date upon which the agreement is |
| | considered to take effect. |
| Type | Text Input |
| Multiple Lines | False |
| Placeholder | Effective Date |
| Text | |
| Embedded | True |
| Required | True |
| State | NoChange |

All properties, except Text, are considered structural. Text is a content property.

Work Product Item 3

| Property | Value |
|---|---|
| Id | 3 |
| WorkProductId | 1 |
| TemplateItemId | 3 |
| Name | Party |
| Description | The person or group of persons that compose a single |
| | entity which are entering the agreement with ABC. |
| Type | Text Input |
| Multiple Lines | False |
| Placeholder | Party |
| Text | |
| Embedded | True |
| Required | True |
| State | NoChange |

Step 3: The User Changes Work Product Item 1 as the User Would Like to Use the Template for a Different Company.

Work Product Item 1

| Property | Value |
|---|---|
| Id | 1 |
| WorkProductId | 1 |
| TemplateItemId | 1 |
| Name | Introduction |
| Description | |
| Type | Paragraph |
| Text | CONFIDENTIALITY AGREEMENT |
| | Date: ##2## |
| | DEF INC. and ##3## (hereinafter |
| | individually referred as the “Party”, the |
| | “Owning Party”, the “Receiving Party”, as |
| | the case may be, and collectively referred |
| | to as the “Parties”) may exchange certain |
| | information that is non-public, confidential |
| | and/or proprietary in nature concerning their |
| | respective businesses, operations and products |
| | which each Party regards to be secret and |
| | desires to protect from unauthorized disclosure |
| | or use (hereinafter collectively, “Information”). |
| | The Parties are willing to disclose Information |
| | (as Owning Party) and receive Information (as |
| | Receiving Party) on the terms and conditions set |
| | forth herein. |
| Embedded | False |
| Required | True |
| State | Modified |

In this example, the name of the ABC INC. has been changed to DEF INC.

Step 4: Analytics

1. Item 1 was modified 100% (1 out of 1) of the time.

2. Item 1 was deleted 0% of the time.

3. The difference in text determined by the longest common sequence.

| | |
|---|---|
| NoChange | CONFIDENTIALITY AGREEMENT |
| | Date: ##2## |
| Deleted | ABC |
| Added | DEF |
| NoChange | and ##3## (hereinafter individually referred as |
| | the “Party”, the “Owning Party”, the “Receiving |
| | Party”, as the case may be, and collectively |
| | referred to as the “Parties”) may exchange certain |
| | information that is non-public, confidential and/ |
| | or proprietary in nature concerning their respective |
| | businesses, operations and products which each Party |
| | regards to be secret and desires to protect from un- |
| | authorized disclosure or use (hereinafter collectively, |
| | “Information”). The Parties are willing to |
| | disclose Information (as Owning Party) and receive |
| | Information (as Receiving Party) on the terms and |
| | conditions set forth herein. |

Unlike Work Product Item 3, as the text component of Work Product Item 1 and Work Product Item 2 are not structural, filling in the content does not change the state of these items.

### EXAMPLE 2

### Process

Step 1: Create the Template

Template

| Property | Value |
|---|---|
| Id | 2 |
| Name | Additional Storage Rollout |
| Version | 1.0 |
| Description | The following plan is to be used to calculate |
| | the amount of new storage required for the system. |
| | The plan will take you through the process of |
| | calculating the amount of new storage that is |
| | required, the quote process, and the physical roll out. |
| Type | Plan |
| Tags | Testing |

Template Item 1

| Property | Value |
|---|---|
| Id | 3 |
| TemplateId | 2 |
| Name | Review Previous Storage Forecast vs. Actual |
| Description | Compare the previous storage forecast to the |
| | actual usage to determine the effectiveness |
| | of the forecast. |
| Type | Task |
| Planned Effort | 6 hours |
| Planned Duration | 1 days |
| Planned Blended Rate | $100 |
| Planned Predecessors | None |
| Required | True |

Template Item 2

| Property | Value |
|---|---|
| Id | 4 |
| TemplateId | 2 |
| Name | Forecast Future Storage Requirements |
| Description | Work with sales, operations, and finance to |
| | forecast the amount of storage that will be |
| | required over the next 90 days. |
| Type | Task |
| Planned Effort | 20 hours |
| Planned Duration | 5 days |
| Planned Blended Rate | $100 |
| Planned Predecessors | None |
| Required | True |

Step 2: Select Template and Create Work Product

Work Product

| Property | Value |
|---|---|
| Id | 2 |
| ReferenceType | Template |
| ReferenceId | 2 |
| TemplateId | 2 |
| Name | Additional Storage Rollout |
| Type | Plan |
| Tags | Operations, Storage |

Work Product Item 1

| Property | Value |
|---|---|
| Id | 3 |
| WorkProductId | 2 |
| TemplateItemId | 3 |
| Name | Review Previous Storage Forecast vs. Actual |
| Description | Compare the previous storage forecast to the |
| | actual usage to determine the effectiveness |
| | of the forecast. |
| Type | Task |
| Planned Effort | 6 hours |
| Planned Duration | 1 days |
| Planned Blended Rate | $100 |
| Planned Predecessors | None |
| Actual Effort | 6 hours |
| Actual Duration | 1 days |
| Actual Blended Rate | $100 |
| Actual Predecessors | None |
| Required | True |
| State | NoChange |

Work Product Item 2

| Property | Value |
|---|---|
| Id | 4 |
| WorkProductId | 2 |
| TemplateItemId | 4 |
| Name | Forecast Future Storage Requirements |
| Description | Work with sales, operations, and finance to |
| | forecast the amount of storage that will be |
| | required over the next 90 days. |
| Type | Task |
| Planned Effort | 20 hours |
| Planned Duration | 5 days |
| Planned Blended Rate | $100 |
| Planned Predecessors | None |
| Actual Effort | 20 hours |
| Actual Duration | 5 days |
| Actual Blended Rate | $100 |
| Actual Predecessors | None |
| Required | True |
| State | NoChange |

Step 3: The User Populates Actual Usage Data for Work Product Item 2

Work Product Item 2

| Property | Value |
|---|---|
| Id | 4 |
| WorkProductId | 2 |
| TemplateItemId | 4 |
| Name | Forecast Future Storage Requirements |
| Description | Work with sales, operations, and finance to |
| | forecast the amount of storage that will be |
| | required over the next 90 days. |
| Type | Task |
| Planned Effort | 20 hours |
| Planned Duration | 5 days |
| Planned Blended Rate | $100 |
| Planned Predecessors | None |
| Actual Effort | 28 hours |
| Actual Duration | 7 days |
| Actual Blended Rate | $100 |
| Actual Predecessors | None |
| Required | True |
| State | NoChange |

As the actual data properties are content properties, updating their values does not change the state of the item.

Step 4: Analytics

The populated actual values are added to the history of actual values populated from previous work products referencing the same template and template item:

Work Products Values

| Effort | Duration | Blended Rate |
|---|---|---|
| 23 | 7 | 100 |
| 18 | 5 | 100 |
| 24 | 7 | 100 |
| 24 | 6 | 100 |
| 28 | 8 | 100 |
| 30 | 8 | 100 |
| 29 | 7 | 100 |
| 30 | 7 | 100 |
| 29 | 7 | 100 |
| 28 | 7 | 100 |

1. The template has been used 10 times.
2. The mean of the Effort needed to complete the task is 26.3 hours. On average it is taking 6.3 more hours to complete the task than is planned for in the template. The standard deviation is 3.7 hours therefore based on usage there is a 68% confidence factor that the task will be completed in 22.6 to 30 hours. The planned effort property of the template should be updated as it is understating the effort required to complete the task.

Similar analytics can be performed for Duration and Blended Rate. Duration and Blended rate are simply numeric. Therefore the same process that was used to calculate the mean and standard deviation of the Effort would be applied to the Duration and Blended Rate. This allows the user of a template to get an accurate picture of the tasks.

Also analytics and alerts can be set at a work efficiency level. It took 29 hours to complete the task the last time. This is outside a standard deviation from the mean therefore a flag can be raised alerting supervisors to the task.

Users or administrators of the system could set up alerts that would be triggered when tasks are taking a longer time then templates indicate they should.

In a further embodiment of the present invention a wizard is provided. A wizard is a collection of questions, each question having a collection of possible answers.

In a further embodiment of the present invention, a wizard may be used to customize a template.

Templates are loaded into the system for users of the system to use. When a user selects a template they are free to customize it by adding, deleting, or modifying items. These changes are recorded and used in the feedback loop. When using a template, i.e. creating a work product, a wizard can be run which will hide sections that do not meet the question/answer criteria.

The standardized templates that exist in the database are customized by the addition of a wizard. The wizard allows for questions and answers to be added to a template. When a work product is derived from a template the user is asked the wizard questions. Based on the users' answers items may be hidden (deleted) from the work product.

In an embodiment of the present invention there is also provided a method to associate rules to a template and the items of a template which will customize the items based on the question/answer combinations of the wizard.

In a further embodiment of the present invention a method in the system is provided to execute the wizard of the associated template on a derived work product. The wizard customizes the work product based on the selected answers to the questions presented. The template and the answers to the wizard questions set describing properties in the database.

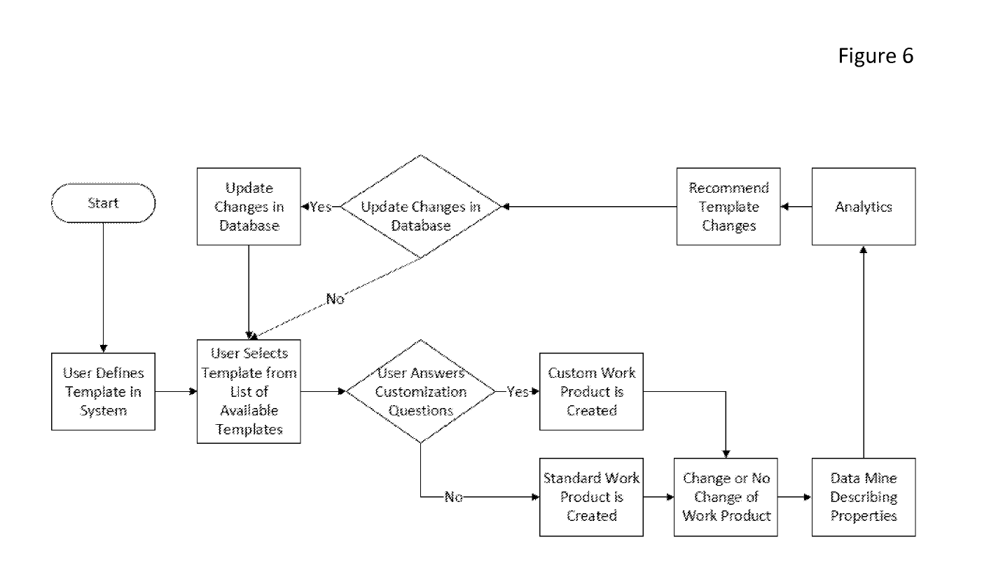

As shown in FIG. 6, a user of the system selects a template from the database. Employing the wizard, the user answers customization questions. The wizard may take the form of a pop up box that appears on a user's screen, or may take any form that allows a user to respond to customization questions. When the wizard is used, each item is associated with a display condition. Each response to a customization question of the wizard may result in that item of the template being hidden from the resulting work product. When no wizard is used, the default of the system is the entire template being shown.

In response to the user's answers to the customization questions, a work product is produced that the user changes or does not change to suit the user's needs. The work product is saved by the user and the changes and no changes, which are describing properties, made to the items of the work product are sent to the database. The database is mined for describing properties associated with the template and analytics are performed on the describing properties. The system will recommend to the user changes that may be made to the template based on the results of the analytics. The user may then either make no changes to the template or may update the template in the database based on the recommendations in which case the next time the template is selected from the database and a work product is created, the template and work product will be from the updated template that reflects the analytics conducted.

For example, in a process for a project, the wizard may include questions relating to the dollar value of a project being undertaken (up to $10,000; $10,000 to $50,000; over $50,000) and the number of resources (individuals) required for the project (1 to 5 resources; 5 to 10 resources; over 10 resources). Responses to these questions that indicate that the value of the project is up to $10,000 and the number of resources is predicted to be between 1 to 5 would result in the wizard hiding items from one or more templates, or entire templates, that would be associated with larger projects. Responses to these questions that indicate that the value of the project is over $50,000 and the resources required is over 10 resources would result in the wizard not hiding any items or templates.

The wizard may also be used to customize a document so that only certain parts of a document will show up as a work product for a use by a user in response to questions asked by the wizard. For example, if the template related to a consulting agreement, the wizard may ask if an outside consultant is being used. If the answer to the question is “no”, the item of the consulting agreement relating to outside consultants would be hidden from the work product.

In the instance of an organizational maturity assessment, the wizard may ask of the user different questions to narrow the data to be collected and organized, for example, questions based on industry, and size of the company.

In an embodiment of the present invention, information from this wizard is also collected and may be analysed. For example, if a wizard results in an item being hidden in a work product, but a user repeatedly pulls up and uses that item, this discrepancy is noted in the describing properties of the item. There is a describing property that indicates that the item was shown or hidden by the wizard, and a further describing property indicating if the item is actually being shown. Analytics that may be performed on the describing properties will point out the discrepancy. The feedback loop will inform the user that the wizard may need to be adjusted in light of the repeated use of an item that is hidden based on the user's response to the wizards' customization questions.

An embodiment of the system of the present invention allows a user of the system to be constantly improving electronic assets such as documents, tasks, plans and assessments. Whereas a user such as a corporation would normally undertake an asset review every few years in a time consuming and repetitive process, an embodiment of the present invention provides a user with real time, constant feedback, having no subjectivity.

User names, passwords and accounts may be associated with each user of the system, as is known in the art. Specific functions and actions of the system may be limited and available only to certain users with permissions. For example, the analytics functionality may only be available to administrative users of the system, and not the regular users. One or more administrative users may also be allowed to create and assign permissions to one or more users.

From the above detailed description, the operation and construction of the invention should be apparent. While there are herein shown and described example embodiments of the invention, it is nevertheless understood that various changes may be made with respect thereto without departing from the principle and scope of the invention.

What is claimed is:

1. A system for constantly improving process efficiency and consistency, comprising:
a. a database storing at least one pre-existing electronic asset;
b. a user interface configured to:
i. allow a user to choose a selected electronic asset from the at least one pre-existing electronic asset, and
ii. automatically create an editable work product based on the selected electronic asset;
c. a change tracking module configured to:
i. automatically create and store to the database a link between the selected electronic asset and the work product, the link comprising at least one describing property, and
ii. automatically store, to the at least one describing property, at least a change to the work product; and
d. a feedback module configured to:
i. automatically analyze a use of the selected electronic asset based on the at least one describing property, and
ii. automatically generate a feedback based on the use of the selected electronic asset.

2. The system in claim 1, wherein
a. the selected electronic asset further comprises at least one asset item,
b. the work product further comprises at least one work product item that may correspond to the at least one asset item, and
c. the link further comprises at least one item link that has at least one item describing property and links the at least one work product item to the at least one asset item corresponding to the at least one work product item.

3. The system in claim 2, wherein the at least one item describing property further comprises a status, the status being selected from a group consisting of: added, deleted, modified, and no-change.

4. The system in claim 2, wherein the user interface is further configured to display a wizard for customizing the work product, the wizard is configured to:
a. show at least one pre-existing question,
b. allow the user to choose from at least one pre-existing answer to the at least one pre-existing question, and
c. automatically determine whether to include the at least one work product item in the work product based on the at least one pre-existing answer.

5. The system in claim 4, wherein the feedback module is further configured to automatically determine an efficacy of the wizard based on the use of the selected electronic asset and include the efficacy of the wizard in the feedback.

6. The system in claim 2, wherein the change tracking module is further configured to automatically store, to the at least one item describing property, at least a change to the work product item, and the feedback module is further configured to automatically analyze the use of the selected electronic asset based on the at least one item describing property.

7. The system in claim 1, wherein the change tracking module is further configured to ignore and not store the at least one change based on where in the work product the at least one change is made.

8. The system in claim 1, wherein the feedback module is further configured to use at least one algorithm for analyzing the use of the selected electronic asset, the at least one algorithm is selected from a group consisting of: count, longest common sequence, min, max, mean, standard deviation, and any combinations thereof.

9. The system in claim 1, wherein the change tracking module is further configured to automatically store, to the at least one describing property, a duration of time that the user used to complete the work product.

10. The system in claim 1, wherein the user interface is further configured to allow the user to manage the at least one pre-existing electronic asset.

11. A method for constantly improving process efficiency and consistency, comprising the steps of:
a. providing a user interface for a user to choose a selected electronic asset from at least one pre-existing electronic asset stored in a database;
b. automatically creating an editable work product based on the selected electronic asset;
c. automatically creating and storing to the database a link between the selected electronic asset and the work product, the link comprising at least one describing property;
d. automatically storing, to the at least one describing property, at least a change to the work product;
e. automatically analyzing a use of the selected electronic asset based on the at least one describing property; and
f. automatically generating a feedback based on the use of the selected electronic asset.

12. The method in claim 11, wherein
a. the selected electronic asset further comprises at least one asset item,
b. the work product further comprises at least one work product item that may correspond to the at least one asset item, and
c. the link further comprises at least one item link that has at least one item describing property and links the at least one work product item to the at least one asset item corresponding to the at least one work product item.

13. The method in claim 12, wherein the at least one item describing property further comprises a status, the status being selected from a group consisting of: added, deleted, modified, and no-change.

14. The method in claim 12, wherein the user interface is further configured to display a wizard for customizing the work product, the wizard is configured to:
a. show at least one pre-existing question,
b. allow the user to choose from at least one pre-existing answer to the at least one pre-existing question, and
c. automatically determine whether to include the at least one work product item in the work product based on the at least one pre-existing answer.

15. The method in claim 14 further comprises the step of automatically determining an efficacy of the wizard based on the use of the selected electronic asset and including the efficacy of the wizard in the feedback.

16. The method in claim 12 further comprises steps of:
a. automatically storing, to the at least one item describing property, at least a change to the work product item, and
b. automatically analyzing the use of the selected electronic asset based on the at least one item describing property.

17. The method in claim 11 further comprises a step of ignoring and not storing the at least one change based on where in the work product the at least one change is made.

18. The method in claim 11 further comprises a step of using at least one algorithm for analyzing the use of the selected electronic asset, the at least one algorithm is selected from a group consisting of: count, longest common sequence, min, max, mean, standard deviation, and any combinations thereof.

19. The method in claim 11 further comprises a step of automatically storing, to the at least one describing property, a duration of time that the user used to complete the work product.

20. The method in claim 11, wherein the user interface is further configured to allow the user to manage the at least one pre-existing electronic asset.
